(19) United States
(12) Patent Application Publication
(10) Pub. No.: US 2026/0197294 A1
(43) Pub. Date: Jul. 9, 2026

(54) DYNAMICALLY-ASSIGNED IP ADDRESSES FOR EXECUTABLE CONTAINER COMPONENTS

(71) Applicant: Nutanix, Inc., San Jose, CA (US)

(72) Inventors: Sunil Khushal Patil, Pune (IN); Gaurav Barmola, Pune (IN); Veeral Prabodhchandra Shah, Pune (IN)

(73) Assignee: Nutanix, Inc., San Jose, CA (US)

(21) Appl. No.: 19/195,345

(22) Filed: Apr. 30, 2025

Related U.S. Application Data
(60) Provisional application No. 63/757,113, filed on Feb. 11, 2025.

(30) Foreign Application Priority Data
Jan. 3, 2025 (IN) 202541000682

(51) Int. Cl. H04L 61/5007; G06F 9/455

(52) U.S. Cl. CPC H04L 61/5007; G06F 9/45558; G06F 2009/45579; G06F 2009/45595

(57) ABSTRACT

Methods, systems, and computer program products for virtualized services implemented within a containerized computing system. Multiple components are operatively interconnected to establish virtualized storage services implemented within a containerized computing system. These methods, systems, and computer program products implement flexible IP network access for storage I/O service handlers in containerized systems. After configuring a storage I/O service handler as one or more executable container components for which its cloud-based logical NIC is given an initial IP address by the containerized system, then identifying one or more reserved IP addresses that are available for use in the containerized system. To assign a new IP address at runtime, in lieu of destroying all or parts of the container components and re-initiating the container components with a newly-assigned IP address, instead, assigning, at runtime, the one or more of the reserved IP addresses to the one or more container components.

### RELATED APPLICATIONS

The present application claims the benefit of priority to U.S. Provisional Patent Application Ser. No. 63/757,113 titled “DYNAMIC IP ADDRESSES FOR PODS,” filed on Feb. 11, 2025, which is hereby incorporated by reference in its entirety; and the present application claims the benefit of priority to India patent application No. 202541000682 titled “DYNAMIC IP ADDRESSES FOR PODS,” filed on Jan. 3, 2025, which is hereby incorporated by reference in its entirety.

### TECHNICAL FIELD

This disclosure relates to virtualized services implemented within a containerized computing system, and more particularly to techniques for dynamically assigning IP addresses to executable container components.

### BACKGROUND

In many containerized virtualization systems (e.g., Kubernetes), an internet protocol (IP) address assignment for an execution deployment unit (e.g., a pod) happens at the time of execution deployment unit creation. Unfortunately, in these same containerized virtualization systems, there is no provision for changing the IP address assignment during runtime. After initial creation of the execution deployment unit, in order to change the IP address that had been assigned to the execution deployment unit, the execution deployment unit would need to be destroyed and recreated.

This situation is troublesome for system developers and system managers alike, at least since many modern virtualization systems rely on flexible migration of virtual machines (a VM or VMs) across environments that do permit dynamic management of the VM's IP address (e.g., during migration). In fact, the ability to dynamically change the IP address of a virtual machine is a critical capability in today's modern virtualization systems, especially modern virtualized applications and/or services that are cloud-based or hybridized (e.g., with some portion of the applications and/or services being hosted in the cloud and some portion of applications and/or services being hosted in an on-premises setting).

The need for the foregoing dynamic IP address management becomes even more critical when one considers that modern virtualized applications and/or services are designed to be extremely resilient (e.g., insensitive to single points of failure), and as such might need to be moved in a flexible manner to a different infrastructure that hosts different (i.e., non-overlapping) sets of outward-facing IP addresses. To further explain, various dynamic IP assignment capabilities that underlie virtualization systems use a combination of (1) virtual IP addresses and (2) IP aliasing functions; which in combinations of (1) and (2) attempt to facilitate dynamic assignment of IP addresses to a process or processes.

The situation becomes more complicated when the aforementioned nodes of the computing cluster are deployed to provide essential capabilities (e.g., capabilities of a storage target, capabilities of a leader node, capabilities of a replication or standby node, etc.) that must be resilient in the face of outages or other situations that cause a loss of functionality to the aforementioned essential capabilities.

Now, with the rapid adoption of containerized systems, the foregoing easy-to-manage, dynamic, and resilient services and/or facilities (e.g., storage-essential capabilities) that have been historically available in virtualized system clusters are now needed to be available in containerized systems.

As mentioned above, it is an unfortunate fact that in certain containerized systems (e.g., Kubernetes) the IP address assignments to execution deployment units are made at the time of execution deployment unit creation and thus, while observing Kubernetes-specific capabilities and semantics, the IP address assignments cannot be changed dynamically after unit creation (e.g., at runtime). For at least the reasons mentioned above, the capability to change an IP address of an execution deployment unit at runtime is needed. Unfortunately, such a capability does not exist in containerized system clusters infrastructure and, as such, what is needed is a way to overcome the deficiencies that arise in the absence of the capability to change an IP address of an execution deployment unit at runtime.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for dynamically assigning IP addresses to executable container components, which techniques advance the relevant technologies to address technological issues with legacy approaches. More specifically, the present disclosure describes techniques used in systems, methods, and in computer program products for assigning published IP addresses dynamically to pods of a containerized computing system. Certain embodiments are directed to technological solutions for implementing a network configuration facility that permits dynamic management of (e.g., changing of) executable service module IP addresses at runtime.

The disclosed embodiments modify and improve beyond legacy approaches. In particular, the herein-disclosed techniques provide technical solutions that address the technical problems attendant to the fact that containerized systems that do not support runtime changes to the IP address of executable service modules. Such technical solutions involve specific implementations (e.g., data organization, data communication paths, module-to-module interrelationships, etc.) that relate to the software arts for improving computer functionality.

The ordered combination of steps of the embodiments serve in the context of practical applications that perform steps for implementing a network configuration facility that permits dynamic changing of executable service module IP addresses at runtime more efficiently. As such, techniques for implementing a network configuration facility that permits dynamic changing of executable service module IP addresses at runtime overcome long-standing yet heretofore unsolved technological problems associated with containerized systems that do not support runtime changes to the IP address of executable service modules that arise in the realm of computer systems.

Many of the herein-disclosed embodiments implement a network configuration facility that permits dynamic changing of executable service module IP addresses at runtime, which are technological solutions pertaining to technological problems that arise in the hardware and software arts that underlie cloud computing. Aspects of the present disclosure achieve performance and other improvements in peripheral technical fields including, but not limited to, hyperconverged computing platform management and distributed storage systems.

Some embodiments include a sequence of instructions that are stored on a non-transitory computer readable medium. Such a sequence of instructions, when stored in memory and executed by one or more processors, causes the one or more processors to perform a set of acts for implementing a network configuration facility that permits dynamic changing of executable service module IP addresses at runtime.

Some embodiments include the aforementioned sequence of instructions that are stored in a memory, which memory is interfaced to one or more processors such that the one or more processors can execute the sequence of instructions to cause the one or more processors to implement acts for implement a network configuration facility that permits dynamic changing of executable service module IP addresses at runtime.

In various embodiments, any combinations of any of the above can be organized to perform any variation of acts for assigning published IP addresses dynamically to pods of a containerized computing system, and many such combinations of aspects of the above elements are contemplated.

Some embodiments include methods for dynamically assigning IP addresses to containerized pods of a containerized system by: (1) configuring one or more executable pods for which its cloud-based logical NIC is given an initial IP address by the containerized system; (2) reserving one or more IP addresses that are available for use in the containerized system environment; and (3) assigning, at runtime, the one or more of the reserved IP addresses to the one or more executable pods.

Some embodiments further comprise moving an assigned one of the one or more of the reserved IP addresses from a first one of the one or more executable pods to a different one of the one or more executable pods. Some embodiments operate wherein the different one of the one or more executable pods is designated to be a leader node. Some embodiments operate wherein at least some operation of the configuring, or the reserving, or the assigning is implemented using a container network interface (CNI). Some embodiments implement a method for executing a storage I/O service handler in a containerized system, the method comprising: (1) configuring the storage I/O service handler as one or more executable pods for which its cloud-based logical NIC is given an initial IP address by the containerized system; (2) reserving one or more IP addresses that are available for use in the containerized system environment; and (3) assigning, at runtime, the one or more of the reserved IP addresses to the one or more executable pods.

Some embodiments operate wherein the storage I/O service handler implements at least one of, a network file system (NFS), Samba, iSCSI, or CIFS and/or a local storage access protocol such as NVMe or PCI-e or peripheral interface variants. Some embodiments implement a method for carrying out an iSCSI packet handling method in a containerized system, the method comprising: (1) configuring multiple iSCSI targets as one or more executable pods that are assigned an initial IP address by the containerized system; (2) reserving one or more dynamic IP addresses that are available for use in the containerized system environment; and (3) assigning, at runtime, the one or more dynamic IP addresses to the one or more executable pods. Some embodiments operate by implementing a CNI function to do network plumbing (e.g., network connectivity). Some embodiments operate by implementing a CNI function to assign the one or more dynamic IP addresses to a leader process and/or its pod.

Some embodiments operate by assigning, at runtime, the one or more dynamic IP addresses to the one or more executable pods. Some embodiments operate by reserving one or more dynamic IP addresses that are available for use in the containerized system environment. Some embodiments operate by configuring multiple iSCSI targets as one or more executable pods that are assigned a static IP address by the containerized system.

Some embodiments implement an iSCSI packet handling method in a containerized system, wherein the method includes (1) reserving one or more IP addresses that are available for use in the containerized system environment; (2) assigning, at runtime, the one or more of the reserved IP addresses to the one or more executable pods; and (3) configuring multiple storage targets as one or more executable pods for which its cloud-based logical NIC is given a static IP address by the containerized system. Some embodiments of such an iSCSI packet handling method implement one or more storage I/O service handlers (for NFS, Samba, iSCSI, CIFS) in a containerized system.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1 illustrates one possible environment in which published IP addresses are dynamically assigned to executable entities of a containerized computing system, according to an embodiment.

FIG. 2A illustrates a first example flow that implements setup and ongoing operations for use in systems that dynamically assign published IP addresses to executable entities of a containerized computing system, according to an embodiment.

FIG. 2B illustrates a second example flow that implements setup and ongoing operations for use in systems that dynamically assign published IP addresses to network-attached storage system components that execute in a containerized computing system, according to an embodiment.

FIG. 3A presents a first example IP address management technique as used in systems that assign published IP addresses dynamically to executable entities of a containerized computing system, according to some embodiments.

FIG. 3B presents a second example IP address management technique as used in systems that assign published IP addresses dynamically to executable entities of a containerized computing system, according to some embodiments.

FIG. 3C1 and FIG. 3C2 depict the effects of an event-driven redirection technique.

FIG. 3D1 and FIG. 3D2 depict an unwanted latency-incurring layer shown as a service abstraction layer for handling redirection when pods of a containerized computing system are used to implement iSCSI storage targets.

FIG. 3E depicts selected advantages of an underlay-oriented network implementation that avoids unwanted characteristics of a latency-incurring service abstraction layer, according to an embodiment.

FIG. 4A presents example worker node interactions that implement setup operations and ongoing operations as are carried out in a Kubernetes setting, according to some embodiments.

FIG. 4B presents an example partitioning of operations as used to configure worker nodes that implement setup operations and ongoing operations that are carried out in a Kubernetes environment, according to some embodiments.

FIG. 5A presents a containerized system having a worker node that carries out configuration operations in a cloud environment, according to some embodiments.

FIG. 5B presents an example partitioning of setup operations as used to configure worker nodes in a cloud environment, according to some embodiments.

FIG. 6A and FIG. 6B depict system components as arrangements of computing modules that are interconnected so as to implement certain of the herein-disclosed embodiments.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with containerized systems that do not support runtime changes to the IP address(es) of executable service modules. These problems are unique to, and may have been created by, various computer-implemented methods for containerized systems and/or by various computer-implemented methods for implementing executable service modules in the context of cloud computing. Some embodiments are directed to approaches for implementing a network configuration facility that permits dynamic changing of executable service module IP addresses at runtime. The accompanying figures and discussions herein present example environments, systems, methods, and computer program products for assigning published IP addresses dynamically to pods of a containerized computing system.

### Overview

In containerized systems, it happens that there is a need to run virtualized services at multiple levels, possibly including services provided by a virtualization operating system that is ported into a containerized environment. Moreover, such containerized systems need to have at least the at-will dynamic IP address functionality provided in or by VM-type virtualization systems. As such, there is a need for a mechanism or mechanisms that allow dynamically assigning IP addresses to executable container components.

Advances in server-client communication pathways that are exploited between providers (e.g., servers) and consumers (e.g., clients) are found in various modern computing settings (e.g., in enterprise data centers, in cloud computing platforms, in virtualization system environments, etc.). That is, various techniques such as network address mappings and/or translations (e.g., via NAT) mechanisms have provided partial solutions for flexibly (e.g., dynamically) assigning IP address to execution units. However, the reliance on such network address mappings and/or translations and/or their particular implementation mechanisms (e.g., protocols) introduce sometimes difficult to overcome challenges, including increased latency, additional routing complexity, and dependency on multiple layers of address translation, any/all of which hinder achievement of optimally-efficient network communications. These issues become more pronounced in highly dynamic environments such as are found in modern computing clusters. Accordingly, there is a need for innovative technologies that advance the art by addressing these deficiencies (e.g., so as to provide better performance and more direct communication pathways, as well as dynamic IP management facilities).

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

Furthermore, an aspect or an advantage described in conjunction with a particular embodiment is not necessarily limited to that embodiment and can be practiced in any other embodiment, even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims. In fact, the disclosed advances may apply to a wide swath of embodiments and computing environments, some of which may involve cloud-hosted capabilities such as Kubernetes.

Aspects of the present disclosure address problems associated with storage-oriented communications in computer systems, particularly those that are highly latency sensitive. These problems are unique to, and may have been created by, various computer-implemented methods for storage-oriented communications, particularly in the context of cloud computing, where latency sensitivity is a critical concern. Some embodiments are directed to approaches for deploying storage modules (e.g., iSCSI targets) having their own dynamically-assigned and dynamically-managed IP addresses. The accompanying figures and discussions herein present example environments, systems, methods, and computer program products for eliminating network address translations and associated IP hops by assigning published IP addresses dynamically to pods of a containerized computing system.

In executable containerized systems, such as Kubernetes, IP address assignments for containerized instances occur during the creation phase, and the IP address, at least while observing Kubernetes-specific capabilities and semantics, cannot be changed dynamically or moved at runtime. This flies in the face of history, at least in the sense that historically, in many clustered virtualization environments IP addresses are dynamically assigned to (for example) controller nodes within the cluster. Due to the desire to run the same infrastructure stack in the executable containerized systems (e.g., Kubernetes environment), a mechanism or technique is needed to enable dynamic IP address changes for containerized instances.

Legacy mechanisms for simulating dynamic IPs for load balancing (e.g., cluster IP service, kube-vip, etc.) involve generating virtual IP addresses outside the pod and then performing network address translation (e.g., via NAT or some other form of IP forwarding) to route traffic to the pods. Similarly, legacy approaches to network-attached storage communication between an initiator and any number of targets involves the use of a service abstraction, which in turn implements one or more of the unwanted network address translation protocols. As is known by those of skill in the art, it is an unfortunate fact that network address translations of communications between an initiator (e.g., an iSCSI initiator) and a target (e.g., an iSCSI target) introduces unwanted network hops (for example) when translating from a public network address to a private network address (and vice versa). More specifically, using NAT introduces additional network processing when translating from a virtual IP address to a non-virtual/actual-IP address (and vice versa).

Unfortunately, even the most modern container network interface (CNI) plug-ins do not provide any mechanism to dynamically assign or remove IP addresses to or from pods. This deficiency is found in various environments, including in containerized systems like Kubernetes, where iSCSI initiators and targets are deployed as pods that have static IP addresses, which static IP addresses retain at least a subset of attributes across lifetimes of an execution unit.

As used herein, the term “static IP” refers to a network address that retains its properties across lifetimes of an executable unit. This is distinguished from, for example, dynamic IP addresses that change properties any time they are assigned to an executable unit.

It should be noted that the foregoing legacy approach (i.e., using a service abstraction layer) provides certain limited advantages, such as enabling communication across isolated network segments, conserving IP addresses, and simplifying network configuration by abstracting the underlying address spaces via an intermediate layer. However, such an intermediate layer, while fostering compatibility between dynamic and static network configurations, has the strongly unwanted effect of introducing deficiencies (e.g., unwanted latency) that limit intermediate layer suitability for modern, performance-critical systems. In particular, the foregoing deficiencies involving NAT are unsuitable for high performance (e.g., low latency, high throughput) applications.

Still further, in the legacy approach, the use of NAT introduces unwanted hops in the communication pathway between the initiator and the targets. These additional and unwanted hops are a consequence of the NAT acting as an intermediary layer, requiring all communication traffic to pass through it for address translation. This extra step introduces significant inefficiencies, specifically (1) the extra step of the NAT consumes CPU cycles, and (1) the NAT processing must handle each data packet by performing address mapping and then routing that packet to the appropriate target. Thus, this intermediary processing creates latency, which latency is strongly unwanted, particularly in containerized environments where dynamic and high-volume communication is imperative.

Even still further, the unwanted hops caused by the service abstraction layer (i.e., where NAT is performed) leads to indirect routing, preventing the initiator and targets from communicating directly. This indirect routing increases the overall path length, which not only adds latency but also creates dependencies on the NAT device itself. These dependencies result in a single point of failure, which means that if the service abstraction layer (e.g., NAT) experiences loss of functionality issues (e.g., overloading, misconfiguration, or outright failure), communication between the initiator and its targets is disrupted or sometimes cut off completely. Such a setup severely impairs the reliability and performance of the system, making it unsuitable for modern, latency-sensitive applications such as network-attached storage applications.

One potential alternative as is found in some legacy implementations involves use of floating IP addresses (e.g., for load balancing). However, this approach has its own set of limitations that arise due to the way that Kubernetes routes traffic to/through worker nodes. Strictly for purposes of illustration, one limitation found in some legacy implementations arises from use of floating IP addresses. A floating IP is an additional IP address assigned to a workload endpoint (e.g., an executable unit). These IPs “float” in the sense that they can be moved around the cluster and refer to different workload endpoints at different times. The endpoint itself is generally unaware of the floating IP. That is, the host uses network address translation (NAT) on incoming traffic to change the floating IP to the endpoint's actual IP address before delivering packets to the workload (and vice versa for outgoing traffic). This adds extra packet processing, which in turn consumes CPU cycles and introduces unwanted latencies. More particularly, use of floating IP addresses forces routes to be observed on/by any/all involved worker nodes, thus introducing both unwanted complexity and unwanted latency.

Dynamically-assigned IP addresses for advanced load balancing Dynamically-assigned IP addresses can also be utilized for advanced load balancing in storage systems. For example, dynamically-assigned IP addresses (e.g., based on a static or otherwise fixed IP address) can be used to redirect iSCSI sessions to different storage service pods or any other types of executable units. In this approach, operational elements (e.g., processes, tasks, services, interrupt handlers, etc.) initiate iSCSI connections by connecting to a dynamically-assigned IP address hosted on one of the storage service pods. When a request is received on the dynamically-assigned IP address, it is redirected to the primary IP address of a storage service pod. This redirection can be based on various factors such as the current state of the storage service pods, their load, or their placement within the cluster. This mechanism ensures that the load is evenly distributed across the storage service pods, improving overall system performance and reliability. Additionally, in scenarios where an established iSCSI session is disconnected (e.g., due to a storage service pod crashing), the operational element can reconnect to the same dynamically-assigned IP address. The system will then redirect the request to one of the available storage service pods, ensuring minimal disruption and high availability.

Such advanced load balancing techniques are not feasible with traditional service abstractions or floating IPs because these IPs exist outside the storage service pods and lack the ability to dynamically adapt to the state or load of individual pods. As such, the dynamically-assigned IP-based load balancing as disclosed herein provides a more flexible and efficient solution tailored to the needs of container attached storage systems.

While legacy approaches such as network address translation (NAT) and floating IP addresses can still be used to facilitate communication between initiators and targets (e.g. iSCSI), their inherent drawbacks (e.g., unwanted latency, dependency on NAT devices, and increased complexity in multi-tenant environments) make them less suitable for modern high-performance systems where greater efficiency and reliability are essential.

These challenges highlight the need for a modernized solution that is specifically designed to address (e.g., eliminate) unwanted latency so as to optimize communication paths between storage initiators and storage targets. More generally, the foregoing legacy approaches fall short in terms of meeting the demands of a wide variety of latency-sensitive applications (e.g., any form of networked storage (e.g., network-attached storage (NAS) and/or storage area networks (SAN), etc.), which are often found in modern computing settings.

As the expectations for low-latency performance continue to grow, a more robust solution is required. At a minimum, this involves eliminating unnecessary hops in the communication pathway. One approach is to implement a more network-aware container networking interface that is aware of the low latency and direct connection needs of any/all of a wide variety of latency-sensitive applications. More particularly, one approach involves implementation of a network-aware container networking interface that facilitates low latency communication and direct connection needs of storage networking. Still more particularly, one approach involves implementation of an iSCSI-aware container networking interface that facilitates the low latency communication and direct connection needs of iSCSI-aware storage networking initiators (e.g., iSCSI initiators) and iSCSI-aware storage networking targets (e.g., iSCSI targets).

### Descriptions of Example Embodiments

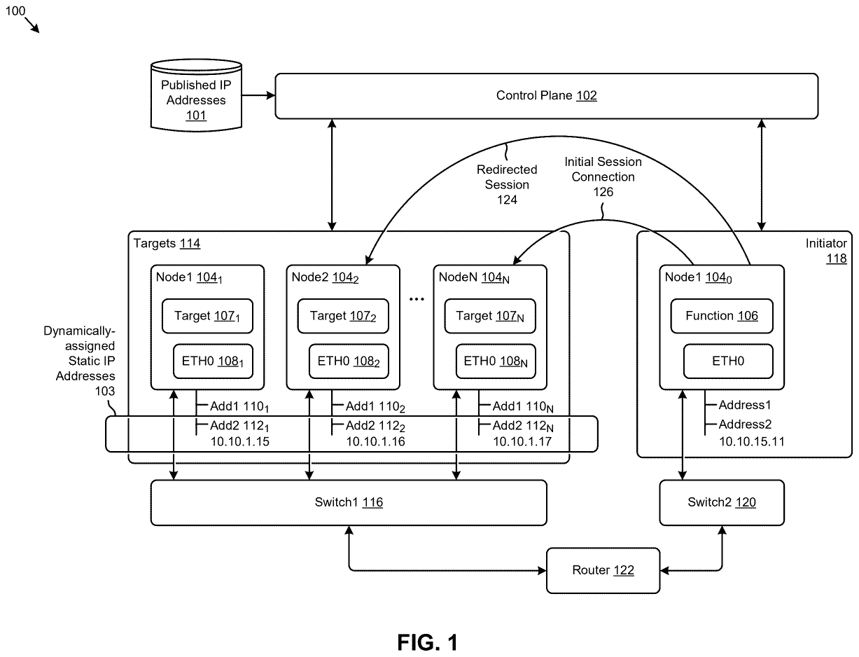

FIG. 1 illustrates one possible environment in which published IP addresses are dynamically assigned to executable entities of a containerized computing system. As an option, one or more variations of environment 100 or any aspect thereof may be implemented in the context of the architecture and functionality of the embodiments described herein and/or in any environment.

The figure is being presented to illustrate how a containerized system might be configured to operate in an environment that supports low-latency communications between an initiator and any number of connected targets. Specifically, and as shown, a node (e.g., node 104₀) of an initiator 118 provides a function 106 (or multiple functions) to any number of targets 114 (e.g., target 107₁, target 107₂, . . . , target 107_{N}) running on any number of nodes (e.g., node1 104₁, node2 104₂, . . . , nodeN 104_{N}).

As can be seen, this architecture-specifically the aspect of this architecture that has multiple clients connected to the same server-provides for redundancy. That is, and as is shown for illustrative purposes, in the event of a client failure (or any sort of impairment of the infrastructure that hosts such a client), a primary client/server session connectivity configuration (e.g., initial session connection 126) can be replaced by a failover client/server session connectivity configuration (e.g., redirected session 124). This architecture supports failback as well, however, in order to provide failover and failback in a flexible manner, the ethernet addresses that facilitate conveyance of network traffic to/from a service (e.g., function 106) and a particular client (e.g., target 107₁, target 107₂, . . . , target 107_{N}) need to be dynamically assigned. This is because the service needs to know how to reach a failover node and/or a failback node.

To accommodate dynamic assignment of an ethernet interface for a particular client, a control plane 102 accesses a repository of published IP addresses 101, and draws from such a repository as needed. In a containerized environment such as Kubernetes, the foregoing clients can run in respective Kubernetes pods, which pods each have a respective ethernet interface (e.g., ETH0 108₁, ETH0 108₂, . . . , ETH0 108_{N}). In most such situations, the ethernet interface can be associated with a first ethernet address (e.g., add1 110₁, add1 110₂, . . . , add1 110_{N}) as well as a second ethernet address (e.g., add2 112₁, add2 112₂, . . . , add2 112_{N}). The second ethernet addresses can be, for example, dynamically-assigned static IP addresses 103.

As can be seen, this architecture supports low latency network communication over hardware networking components that operate without the need for network address translation. In the particular embodiment of FIG. 1, the service is hosted on a node that is on a subnet that is distinct from the subnet that is used for the nodes that host the clients. In this configuration, communication between subnets is accomplished through use of a router 122 that interfaces with two different switches (e.g., switch1 116 and switch2 120).

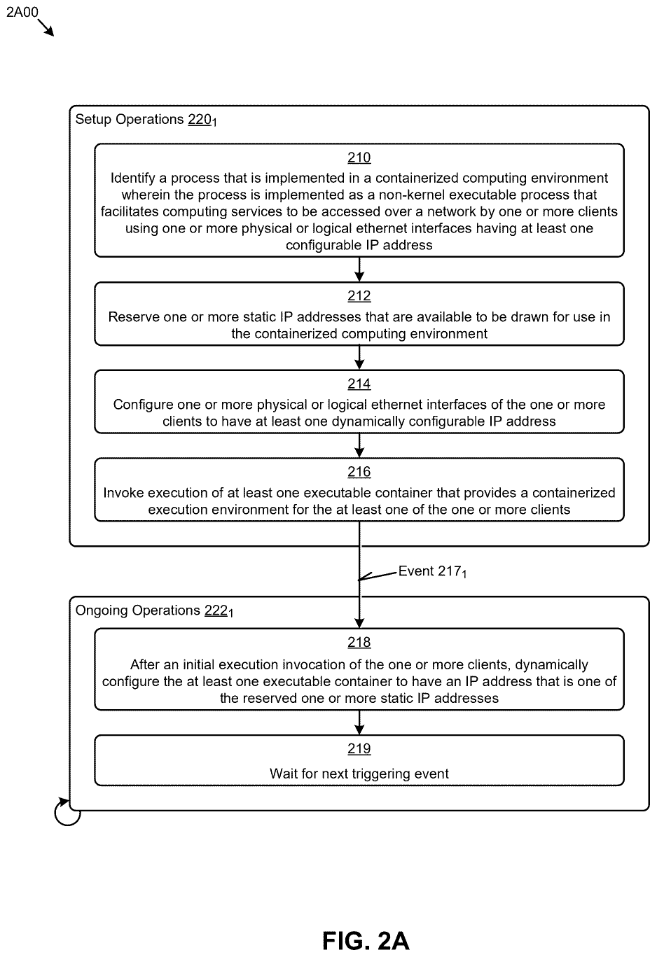

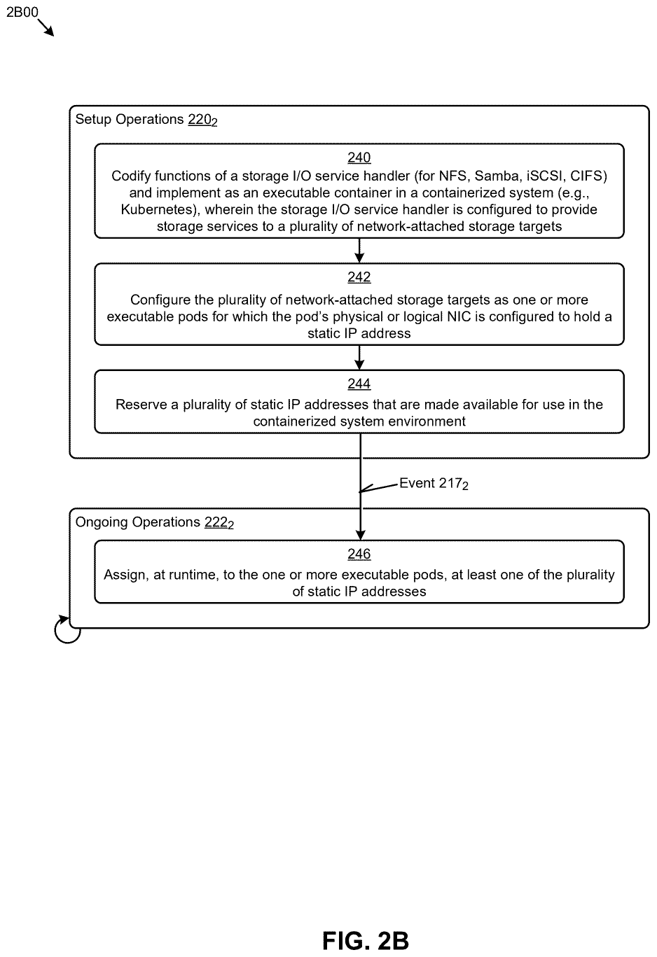

The foregoing discussion of FIG. 1 pertains to merely some possible embodiments. Many variations are possible. For example, the embodiment as comprehended in the foregoing can be implemented in any environment, and/or can implement any sorts of services and/or can be established using any of a variety of setup sequences and ongoing operations, some examples of which are shown and described as pertains to the following FIG. 2A and FIG. 2B. More particularly, the following FIG. 2A pertains to a generalized client/server configuration, whereas FIG. 2B pertains to a storage-centric initiator/target configuration.

FIG. 2A illustrates a first example flow that implements setup and ongoing operations for use in systems that dynamically assign published IP addresses to executable entities of a containerized computing system. As an option, one or more variations of flow 2A00 or any aspect thereof may be implemented in the context of the architecture and functionality of the embodiments described herein and/or in any environment.

The figure is being presented to illustrate how a flow might be configured to operate in an environment that implements setup and ongoing operations for use in systems that dynamically assign published IP addresses to executable entities of a containerized computing system.

As shown the flow is divided into a set of setup operations 220₁ and a set of ongoing operations 222₁. The shown setup operations, which comprise step 210 through step 216, can be carried out at any convenient moment, whereas the shown ongoing operations, which comprise step 218 and step 219, can be invoked any time after completion of at least some of the setup operations, and based on the occurrence of some sort of triggering event (e.g., event 217₁).

To explain how the setup flow works, consider that one reason why the setup operations might be carried out is the determination that a service (e.g., a process that is implemented in a containerized environment) needs to serve multiple clients, at least some of which clients are situated in the same (or different) containerized environments. More particularly, step 210 serves to identify a process that is implemented in a containerized computing environment wherein the process is implemented as a non-kernel executable process that facilitates computing services to be accessed over a network by one or more clients using one or more physical or logical ethernet interfaces. In exemplary containerized environments, such services and corresponding clients have at least one configurable IP address, which IP address can be drawn (step 212) from a set of reserved IP addresses (e.g., static IP addresses).

Any one (or more) of the drawn IP addresses can be assigned a priori to one or more physical or logical ethernet interfaces (step 214). At a later moment, the drawn IP address can be configured into an ethernet interface that in turn will serve as source points or destination points of a client. Such a client, having been associated with the foregoing ethernet interface, can be invoked (step 216) to execute within a containerized execution environment. It should be recognized that many containerized systems implement the concept of a lowest level execution unit (e.g., a Kubernetes pod), and further it should be recognized that such a lowest level execution unit is subject to the particular implementation of the containerized environment.

In Kubernetes, the lowest level execution unit is a pod. Kubernetes pods are associated with a Kubernetes-assigned ethernet address which, while observing Kubernetes-specific capabilities and semantics, cannot be changed dynamically or moved at runtime. This limitation is overcome by the herein-disclosed technological advances. More specifically, this limitation is overcome by combining an IP address reservation system (e.g., such as is contemplated by step 212) with a mechanism that dynamically configures (e.g., overrides) the ethernet interfaces of a pod with one of the reserved IP addresses. This dynamic configuration (e.g., overriding) can be carried out upon occurrence of a triggering event (e.g., event 217₁). In fact, and as shown, it might happen that there might be many occurrences of triggering events (e.g., asynchronous triggering events) that cause an executable container (e.g., a pod) to take on a newly-determined and/or dynamically-assigned IP address.

The foregoing triggering event might occur at any moment in time. The triggering event might invoke any set of ongoing operations 222₁, which ongoing operations might include waiting until after an initial execution invocation of the one or more clients, then dynamically configuring an executable container to have an IP address that is a reserved IP addresses (step 218). In the foregoing as well as in other cases, the ongoing operations move into a wait state, where the ongoing operations pend until such time as a next triggering event is detected (step 219).

Now, returning to the explanation of the reason for presenting this figure, those of skill in the art will recognize the significance of the advance here; namely that, at least with respect to the fact that when observing Kubernetes-specific capabilities and semantics, the IP address of a pod cannot be changed dynamically (e.g., at runtime) after pod creation. Rather, when relying solely on Kubernetes-provided verbs, the IP address of a running pod is only changed when the old pod is destroyed and a new pod is configured, and as such a technique such as is depicted in FIG. 2A is needed.

The foregoing discussion of FIG. 2A pertains to merely some possible embodiments and/or ways to implement the advance. Many variations are possible, for example, the flow for a generalized client/server configuration as comprehended in the foregoing can be implemented in any environment and/or for one or more particular purpose. One example flow involving configuration of a storage initiator (e.g., an iSCSI initiator) and storage targets (e.g., iSCSI targets) is shown and described as pertains to the following FIG. 2B.

FIG. 2B illustrates a second example flow that implements setup and ongoing operations for use in systems that dynamically assign published IP addresses to network-attached storage system components that execute in a containerized computing system. As an option, one or more variations of flow 2B00 or any aspect thereof may be implemented in the context of the architecture and functionality of the embodiments described herein and/or in any environment.

The figure is being presented to illustrate one way to configure a storage initiator (e.g., an iSCSI initiator) and storage targets (e.g., iSCSI targets). Moreover, the figure is being presented to illustrate one way to accomplish cooperation between a set of setup operations 220₂ and a set of ongoing operations 222₂.

As shown, the flow commences at step 240, where a storage I/O (input/output or IO) service handler is codified into an executable container. Such a storage I/O service handler might be configured to handle any storage access protocol and/or any file system verbs, of which the well-known “network file system” (NFS), and/or the well-known network file protocol “server message block” (SMB or Samba), and/or the “common internet file system” (CIFS), and/or the well-known “internet small computer systems interface” (iSCSI) are merely examples. Such a storage I/O service handler, sometimes called a “storage initiator” or “iSCSI initiator,” can interface with any number of network-attached storage targets, of which an “iSCSI storage target” is merely one example.

As used herein a storage I/O service is an operational unit that implements at least a portion of a protocol that is implemented from within a non-kernel executable process that allows storage devices to be accessed over a network, (i.e., storage devices are networked so as to enable access to the network-attached storage devices).

In various embodiments, including the embodiment of FIG. 2B, a network-attached storage target can be deployed as or into an executable container (step 242). More particularly, such an executable container can be configured to serve as network-attached storage targets that are deployed as one or more executable pods. Still more particularly, the executable pod's physical or logical network interface card (NIC) can be configured to hold a static IP address (shown in step 242). As previously disclosed hereinabove, having a pod that can take on re-addressing (e.g., via the pod's IP address) results in flexibility that is not possible when relying solely on Kubernetes-provided verbs. To further this flexibility, a pool of static IP addresses is formed to be managed on an ongoing basis (step 244). Such a pool can serve or otherwise make available any number of static IP addresses that can in turn be dynamically assigned to a pod.

With the foregoing setup operations being at least partially accomplished, the deployment is in a condition such that any pod can take on a new IP address merely by changing assignment of the pod's physical or logical ethernet interface to a particular static IP address.

It can sometimes happen that static IP addresses that are known to the iSCSI initiator are used when populating the pool (step 244). This is because the iSCSI initiator might need to know a priori what static IP addresses are available to use for corresponding iSCSI targets. More particularly, the iSCSI initiator might need to know which iSCSI targets are primary iSCSI targets and which iSCSI targets are replica iSCSI targets or standby iSCSI targets.

Now, with the foregoing setup operations being at least partially accomplished, ongoing operations 222₂ can commence, and as shown, do commence upon occurrence of event 217₂. Such an event may be raised for many reasons. For example, event 217₂ might be raised based on a failure or even a partial loss of functionality of one of the plurality of iSCSI targets. In such a situation, a replacement iSCSI target pod can take on one of the static IP addresses-even as the replacement iSCSI target pod is executing (step 246). The technological advance here should be apparent, at least since it is known to those of skill in the art that dynamic re-assignment of an IP address to a running pod is not possible when relying solely on Kubernetes-provided verbs.

The foregoing discussion of FIG. 2B pertains to merely some possible embodiments. Many variations are possible, for example, the flow as comprehended in the foregoing can be implemented in any environment, one example of which is shown and described as pertains to the following figure.

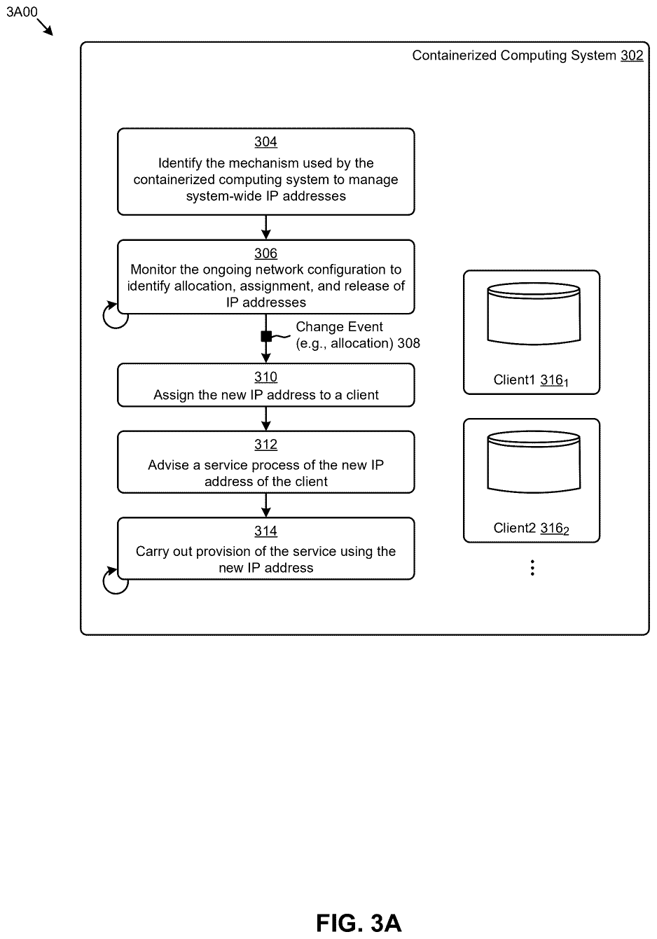

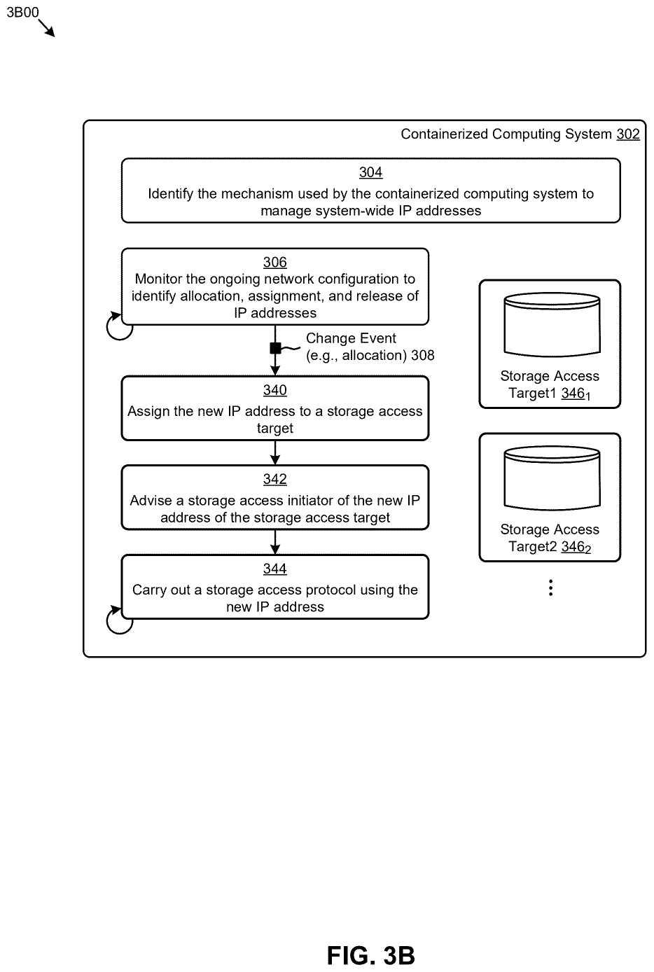

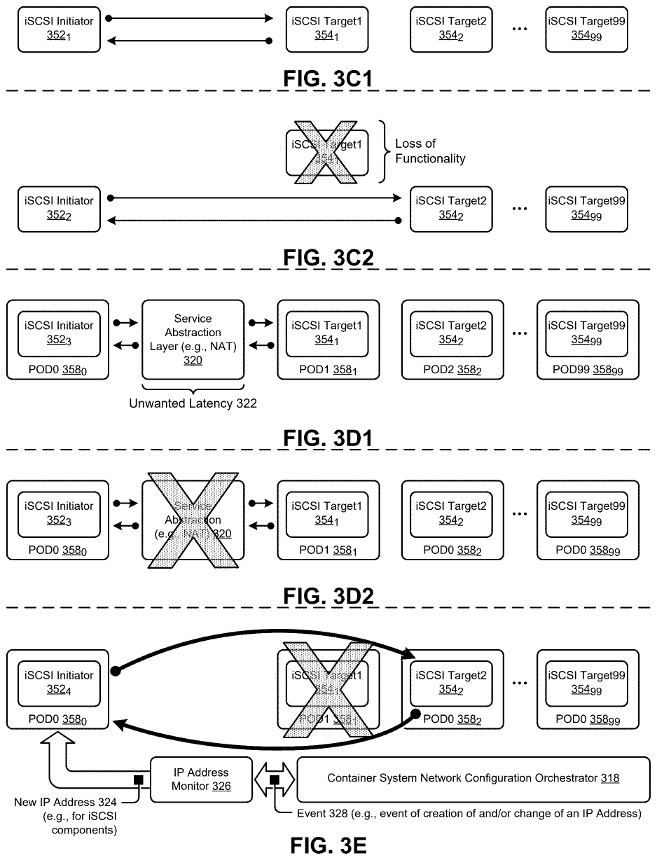

FIG. 3A presents a first example IP address management technique as used in systems that assign published IP addresses dynamically to executable entities of a containerized computing system. As an option, one or more variations of IP address management technique 3A00 or any aspect thereof may be implemented in the context of the architecture and functionality of the embodiments described herein and/or in any environment.

The astute reader will recognize that the IP address assignment techniques of the foregoing FIG. 2A and FIG. 2B perform the assignment and establish network communications between a storage initiator and one or more storage targets without the need for address translation. That is, the techniques of FIG. 2A and FIG. 2B do not rely on network address translation (NAT) to be performed in order to route traffic to/from the storage initiator and one or more storage targets. Rather, the actual dynamically-assigned IP address of a storage target is known by the storage initiator and, as such, no network address translation is needed. This is a needed technological advance, at least in that eliminating the need for NAT reduces latency in the network communications between a given storage initiator and its interconnected storage targets.

The foregoing technological advance (e.g., eliminating the need for NAT) can be implemented in any containerized system and in the context of any service that provides functionality to clients. FIG. 3A presents a generalized way to configure components of a containerized system when deploying a server/client capability, whereas FIG. 3B presents a storage-centric view of configuring components of a containerized system when deploying network-attached storage.

FIG. 3A shows an IP address management technique for eliminating network address translations and associated IP hops that can take place between a server and its client by assigning published IP addresses dynamically to pods of a containerized computing system. More particularly, FIG. 3A pertains to a containerized computing system 302, which includes clients (e.g., client1 316₁, client2 316₂, . . . ). The figure first identifies (at step 304) the mechanism used by the containerized computing system to manage system-wide IP addresses. In this sense, the term “system-wide” refers to a scope broader than a single subnet (e.g., spanning multiple subnets or nodes). This step can be practiced in any environment. More particularly, it happens that different containerized systems support different mechanisms. Moreover, the various mechanisms might be specified and/or invoked and/or probed and/or modified using any of a variety of computerized coding. Strictly as examples, the foregoing various mechanisms might be specific and/or invoked and/or probed and/or modified using any one or more of, calling an application programming interface, launching an executable agent, carrying out a protocol, setting a flag, etc.

Once this mechanism for managing system-wide IP addresses is established, the focus shifts to the inner flow, beginning with the shown ongoing monitoring operations. Specifically, the system monitors ongoing network configuration changes to identify the allocation, assignment, and release of IP addresses (step 306). Upon an occurrence of a change event 308 (e.g., an allocation event), the system responds accordingly.

In some situations, the response is that a new IP address is assigned to a client (step 310), and a corresponding service process is advised of the new IP address of the client (step 312). Now complete, the final step is to invoke the subject service process to carry out a storage access protocol using the new IP address (step 314). The process allows for direct communication with no NAT and no additional hops, enabling faster, more efficient data transfer between the service and clients. Still further, this direct communication architecture eliminates the latency and overhead that would typically be introduced by intermediary layers, thus ensuring optimal performance and reliability in containerized environments. Additionally, in containerized or virtualized systems, dynamically-assigned IP addresses adapt to changing workloads. This ensures that communication remains efficient even as storage systems scale.

The foregoing discussion of FIG. 3A pertains to merely some possible embodiments and/or ways to implement low latency network communications between server/initiators and client/targets. Many variations are possible, for example, the low latency network communications paths as comprehended in the foregoing can be implemented in any environment, one example of which is shown and described as pertains to the FIG. 3B.

FIG. 3B presents a second example IP address management technique as used in systems that assign published IP addresses dynamically to executable entities of a containerized computing system. As an option, one or more variations of IP address management technique 3B00 or any aspect thereof may be implemented in the context of the architecture and functionality of the embodiments described herein and/or in any environment.

FIG. 3B differs from FIG. 3A at least in that the operational modules (e.g., storage access target1 346₁, storage access target2 346₂, . . . , etc.) and operations shown (e.g., step 340, step 342, and step 344) are specially-configured to implement a network-attached storage protocol (e.g., iSCSI). To explain further:
1. Step 340 of FIG. 3B dynamically assigns a static IP address to a storage access target rather than assigning such a new IP address to a client as shown and discussed as pertains to FIG. 3A.
2. Step 342 of FIG. 3B advises a storage access initiator of the storage access target rather than dynamically assigning a static IP address to a service process as shown and discussed as pertains to FIG. 3A.
3. Step 344 of FIG. 3B carries out a storage access protocol using the new IP address rather than carrying out the function of the service process as shown and discussed as pertains to FIG. 3A. As shown, the carrying out of the storage access protocol using the new IP address rather than carrying out the function of the service process can continue on an ongoing basis.

The foregoing discussion of FIG. 3B pertains to merely some possible embodiments and/or ways to implement an IP address management technique. Many variations are possible; for example, the IP address management technique as comprehended in the foregoing can be implemented in any environment. Moreover, the foregoing IP address management technique can be used in parallel, or rather than, or in cooperation with, any storage protocol failover/failback or redirection functionality. One example of an iSCSI redirection (possibly implemented in a failover/failback scenario) is shown and described as pertains to the FIG. 3C1 and FIG. 3C2.

FIG. 3C1 and FIG. 3C2 depict the effects of an event-driven redirection technique. As an option, one or more variations of event-driven redirection technique as shown in FIG. 3C1 or any aspect thereof may be implemented in the context of the architecture and functionality of the embodiments described herein and/or in any environment.

FIG. 3C1 and FIG. 3C2 illustrate a legacy approach to the communication pathways between an initiator and their corresponding targets. As shown, the communication paths involve an iSCSI initiator 352₁ and corresponding iSCSI targets (e.g., iSCSI target1 354₁, iSCSI target2 354₂, . . . , iSCSI target99 354₉₉). More specifically, FIG. 3C1 and FIG. 3C2 are presented to illustrate the traditional communication pathway, where an initiator (e.g., iSCSI initiator 352₁) must establish individual connections to each target (e.g., iSCSI target1 354₁, iSCSI target2 354₂, . . . , iSCSI target99 354₉₉). This approach requires the initiator to explicitly address and communicate with each target directly, resulting in static and rigid communication pathways that are not beneficial in containerized environments.

To emphasize the problem with this legacy architecture and corresponding legacy approaches to addressing this problem, it can be seen as in FIG. 3C1 that the iSCSI initiator establishes a direct connection to each iSCSI target without using an abstraction layer. Unfortunately, this legacy architecture requires manual configuration and creates rigid communication pathways. If a target becomes unavailable, such as depicted in FIG. 3C2, then the pathway fails, requiring protocol remediation and/or other intervention to restore connectivity. For example, if some event such as a loss of functionality of a target (e.g., loss of functionality of iSCSI target 1 354₁) causes the iSCSI redirection protocol to be executed, which in turn causes iSCSI initiator 352₂ to take the affected iSCSI target out of the communication path. As such, traffic that was originally intended for the affected iSCSI target is or would be redirected to a different iSCSI target.

In containerized systems such a Kubernetes, a storage initiator is isolated from its target using a service abstraction layer. Unfortunately, implementation of a service abstraction layer involves an extra network hop (e.g., via NAT), and thus fails to address redirection that maintains low latency communication paths even within containerized environments. Nevertheless, even though an extra network hop (e.g., as implemented in a service abstraction layer) is strongly unwanted, especially in applications or services that are performance-wise sensitive to latency, it is nevertheless the unfortunate implementation choice that is found in various containerized environments.

FIG. 3D1 depicts an unwanted latency-incurring layer shown as a service abstraction layer for handling redirection when pods of a containerized computing system are used to implement iSCSI storage targets. This service abstraction layer 320 incurs unwanted latency 322 as a consequence of handling redirection when pods of a containerized computing system are used to implement iSCSI storage targets. In addition to unwanted introduction of an extra network hop (i.e., a latency-incurring hop), the service abstraction layer introduces as strongly unwanted single point of failure that arises due to the architectural deficiency of having a service abstraction layer 320 situated between an iSCSI initiator 352₃ (e.g., pod0 358₀) and its storage target pods (e.g., pod1 358₁, pod2 358₂, . . . , pod99 358₉₉).

Specifically, and referring to the depiction of FIG. 3D2, it can be seen that failure or loss of functionality of the shown service abstraction layer 320 causes a complete loss of intended functionality of the storage network. Improved approaches are needed, one of which such improved approaches is shown and described as pertains to FIG. 3E.

Low Latency and High Availability Containerized Components for iSCSI

Consider a deployment in a containerized system in which there is a KUBE-Proxy that is aware of the server configuration (e.g., iSCSI fabric). Strictly as one example of such a containerized system, and strictly for purposes of illustration, consider an approach wherein a containerized networking interface is configured to be iSCSI aware.

FIG. 3E depicts selected advantages of an underlay-oriented network implementation that avoids unwanted characteristics of a latency-incurring service abstraction layer. More particularly, FIG. 3E illustrates architectural aspects of this approach. Specifically, and as shown, a container system network configuration orchestrator 318 is implemented, which orchestrator then causes the event 328 of creation of and/or change of IP address, which event is in turn recognized by or causes invocation of an IP address monitor 326, which then forwards the new IP address 324 to PODO 358₀. This solution enables the iSCSI initiator 352₄ to communicate directly with each surviving iSCSI target (e.g., iSCSI target2 354₂ . . . , iSCSI target99 354₉₉) without relying on operations of an intermediate layer such as would be incurred by a service abstraction layer and/or without relying on operations of some form of address translation table such as would be incurred by the NAT protocol. This innovative approach dynamically assigns or removes additional IP addresses to or from pods at runtime, thus allowing the service running inside the pod to use these new IP addresses-yet without incurring unwanted latency.

To explain one way to implement this advance, consider an agent (e.g., a KUBE-Proxy) that is aware of the server's configuration (e.g., including the iSCSI fabric). Specifically, and again referring to a Kubernetes environment, one convenient solution is to implement a container networking interface or custom container networking interface and make it iSCSI aware. This is accomplished at runtime by assigning (or removing, or otherwise managing) additional IP addresses and then invoking or otherwise facilitating one or more services running inside a pod to assign an additional IP address for one or more particular use cases. Strictly as examples, said use cases might include provisions for load balancing, provisions for security, provisions for fast failover and failback, etc.

### Use of a Kubernetes Custom Resource Definition Facility

In Kubernetes-specific embodiments, a custom resource definition (CRD) for defining additional IP addresses for pods is created. Such a custom resource definition has fields for pod identifiers and corresponding IP addresses. A custom controller reads the IP addresses from the CRD and applies a particular (e.g., application-specific) IP configuration to specified pods.

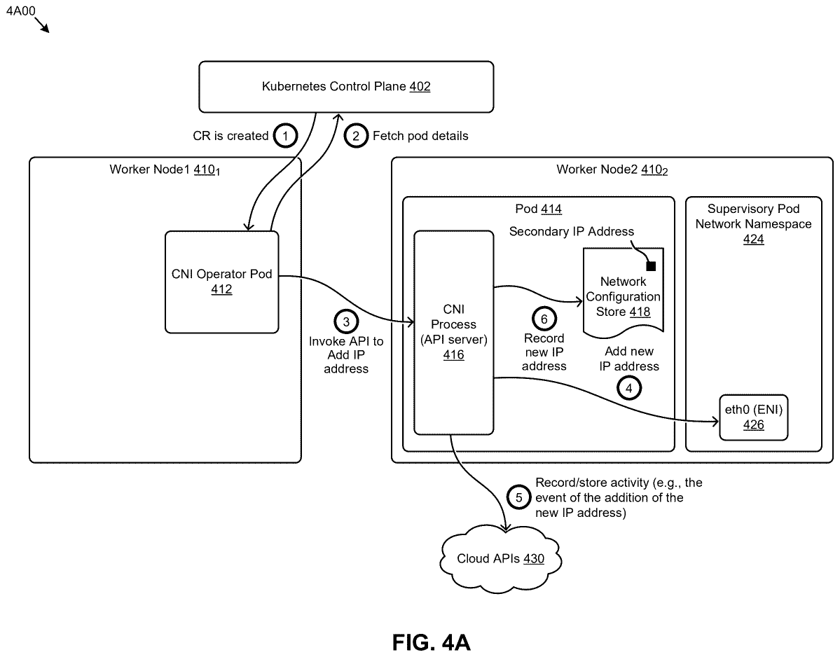

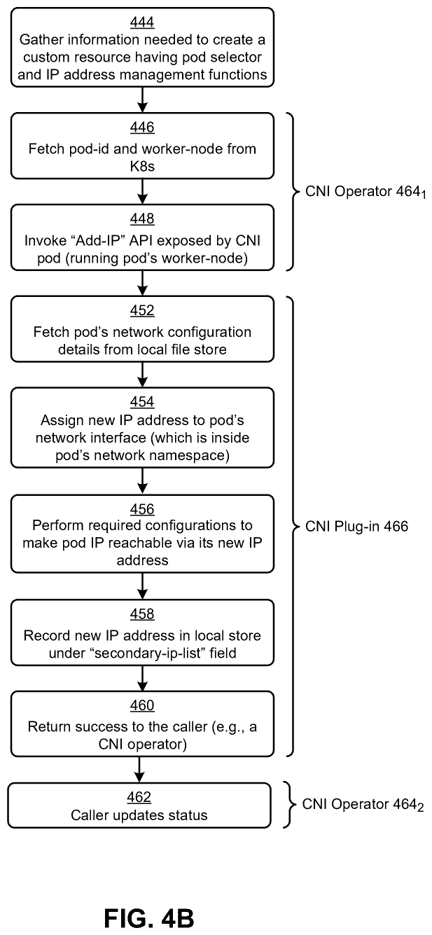

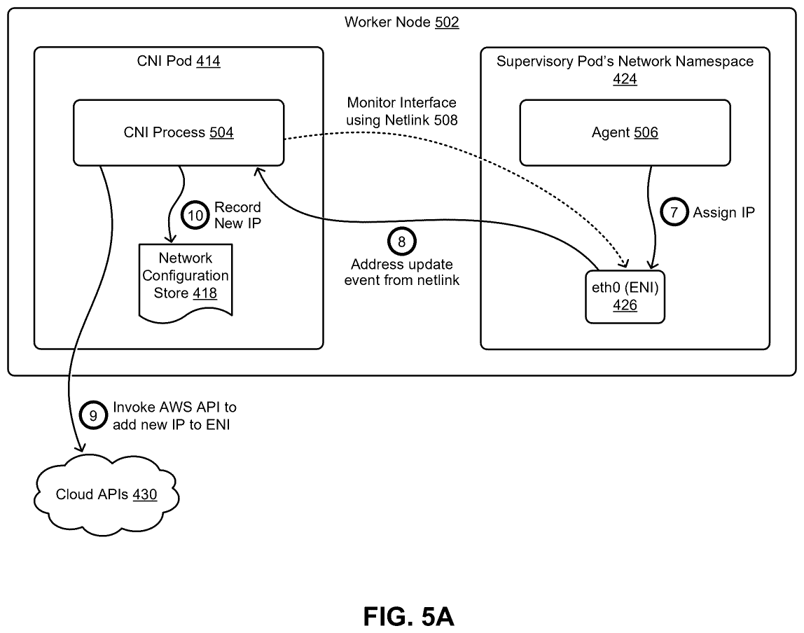

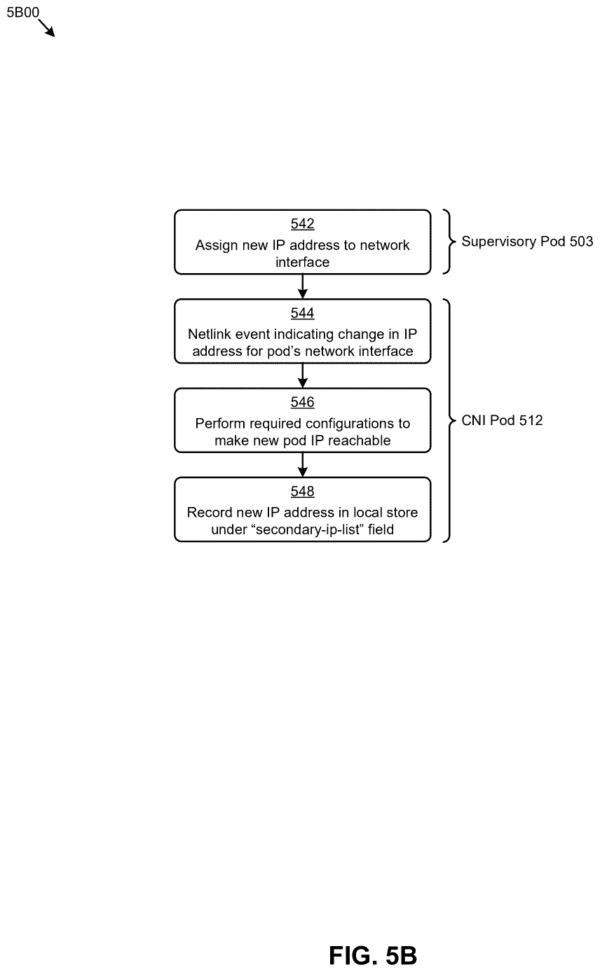

Now, returning to the discussion of the figure flow of FIG. 3A through FIG. 3E, it becomes clear via the provided comparisons between the disclosed invention and legacy approaches, that less optimal techniques such as reliance on network address translation (NAT) and indirect routing for allowing dynamic assignment of IP addresses can be improved. In particular, in the context of an iSCSI fabric, the disclosed techniques (e.g., the techniques discussed supra as pertains to FIG. 3E) offer significant improvements in networking efficiency by enabling direct communication pathways between iSCSI initiators and iSCSI targets. This approach not only minimizes latency but also simplifies configuration and enhances scalability in containerized environments. Furthermore, this approach can be implemented in a variety of different embodiments, which different embodiments can be implemented using known-in-the-art node configuration techniques (e.g., partitioning techniques), a sample of which embodiments are shown and described as pertains to FIG. 4A, FIG. 4B, FIG. 5A, and FIG. 5B.

FIG. 4A presents an embodiment wherein a worker node 410₁ implements setup operations and ongoing operations that are carried out in a Kubernetes setting. As an option, one or more variations of worker node interactions 4A00 or any aspect thereof may be implemented in the context of the architecture and functionality of the embodiments described herein and/or in any environment, including in public or private cloud environments.

This particular set of worker node interactions 4A00 avails of the functionality of a custom CNI plug-in. In consonance with the foregoing approach of FIG. 3E, the shown worker node interactions combine to eliminate network address translations and associated IP hops. As heretofore mentioned, legacy deployments, including CNI plug-ins, do not provide any mechanism to dynamically assign/remove the IP address associated with pods. Moreover, even though there are various legacy mechanisms for creating virtual IPs (e.g., for load balancing or for cluster IP servicing such as kube-vip), such techniques create virtual IP addresses outside the pod and then institute NAT address translation protocols and/or IP forwarding protocols, either or both of which incurs unwanted latency whenever sending traffic towards the pods. As such there is a need for advances in approaches to handling IP addresses.

As shown, the custom resource (CR) is created from the Kubernetes control plane 402 (via operation 1), within worker node1 410₁. As discussed in this embodiment, a CR is a specification that extends the Kubernetes control plane. Once instantiated and initiated, the container networking interface (e.g., container networking interface operator pod 412) then makes calls (by way of operation 2) to the Kubernetes control plane 402 to fetch pod details (e.g., pod-id and worker node from K8s). Next, (via operation 3) the container networking interface operator pod 412 invokes an API to “Add-IP Address” within pod 414 of worker node2 410₂ A container networking interface process 416 (e.g., shown as API server) adds the new IP address (via operation 4) by assigning it to the eth0 interface (ENI 426) within the namespace of another pod's namespace (e.g., the supervisory pod's network namespace 424). It should be noted that any particular pod's namespace (e.g., the supervisory pod's network namespace 424) can have its own isolated namespace and/or stack of operational/supervisory layers.

When the container networking interface process 416 then invokes (via operation 5) an API of the host web services environment so as to add the new IP to the database of the web services environment, the container networking interface process concurrently or sequentially records the new IP address in the network configuration store 418 (operation 6).

As can be seen, a new IP address (e.g., a static IP address) is added to a pod at runtime. Moreover, such a new IP address becomes configured into the web services environment such that the newly configured operational unit can avail of any resources of the web services environment.

It should be noted that a CNI can be partitioned into two components: (1) a CNI operator and a CNI plug-in. The various operations needed to implement all of operation 1 through operation 6 can be partitioned in any manner, one of which such manner is shown and described as pertains to FIG. 4B.

FIG. 4B depicts a flow of steps (e.g., step 444 through step 462), any of which steps can be partitioned using any known technique. In the particular example of FIG. 4B, individual steps are assigned conveniently to either a CNI operator or to a CNI plug-in. There may be other components in other partitions that participate in the setup and ongoing operation of a CR. For example, different ones of the operations within the flow that proceeds from step 444 through step 462 may be implemented variously by a first portion of a CNI operator 464₁, or may be implemented by a second portion of a CNI operator 464₂. Furthermore, and as shown, certain ones of the operations within the flow that proceeds from step 444 through step 462 may be implemented by CNI Plug-in 466.

As shown, operations subordinate to step 444 serve to, directly or indirectly, gather information needed to create the aforementioned CR such that the CR implements aspects or features of (1) a pod selector and (2) various IP address management functions. A pod can be selected based on name, id, labels or any other individual property or combination of properties that uniquely identify that pod.

In one particular embodiment, such gathering of information needed to create the aforementioned CR might entail fetching pod IDs and worker node IDs from the Kubernetes environment (step 446). In example cases, specifically in the Kubernetes environment, the information heretofore gathered can be used to invoke an “Add-IP” API, such as would be exposed by the CNI pod. The CNI pod is configured such that it can access any pod that is situated on a worker-node (step 448).

Then, in order to know how and where to dynamically assign new IP addresses to the pod (or other sort of executable container component), the subject pod's then-current network configuration is fetched, the details of which network configuration might be drawn from a local file store (step 452). Thereafter it is possible to assign a new IP address to the pod's network interface (step 454) which, in this example Kubernetes configuration, is inside the subject pod's network namespace. In some cases, there may be additional operations (e.g., configuration-specific operations) to be performed so as to make the pod IP reachable via its new IP address (step 456). Thereafter, the new IP address is recorded in some local storage facility field (step 458) and the status (e.g., “success” status) of the call (e.g., originating from a CNI operator) is returned to the caller (step 460). The caller (e.g., a CNI operator) then updates (at step 462) its status (e.g., CR status).

The foregoing discussions of FIG. 4A and FIG. 4B correspond to merely one implementation. Other implementations are possible including implementations that are congruent to the former web services example, and yet are specific to a particular web services environment and/or are specific to a particular cloud environment. For example, consider an iSCSI traffic handling system for iSCSI packet handling where the system operates in a Microsoft (or other vendor's) containerized system environment wherein multiple iSCSI targets are implemented as pods (or the corresponding equivalent of Kubernetes pods) and wherein individual ones of the pods are assigned a respective static IP address by the containerized system. The desired iSCSI traffic handling system for iSCSI packet handling can be brought to bear by configuring a pod of a node of the containerized system environment to process a dynamic IP address wherein the processing of the dynamic IP address includes assigning the dynamic IP address (e.g., a secondary IP address) to a respective pod as an assigned dynamic IP address of the respective pod; and then using the at least one assigned dynamic IP address of the respective pod during runtime for routing the iSCSI traffic.

The foregoing iSCSI packet handling system can be implemented, in whole or in part, by a container network interface (e.g., an interface such as an API to interact with a CNI or similar operator) that runs inside the pod. In such cases, the custom service is configured to assign the at least one additional IP address to the pod for routing iSCSI traffic to a different pod. Some implementations are brought to bear as a plug-in that performs ongoing monitoring of a network namespace of the pod to get IP address assignment events (and/or release or un-assignment events).

As an example, an iSCSI packet handling system might perform ongoing monitoring using network configuration events (e.g., in an event-driven implementation) or by periodically checking IPs (e.g., in a polling implementation) on the pod interface to identify changes (e.g., by comparing a current state with a previous state). In some implementations, the iSCSI packet handling system stores at least some of, a pod-id, a pod-network-namespace, a pod-interface-name, a pod's primary IP address, a pod's secondary IP address, etc.

The foregoing discussion of FIG. 4A and FIG. 4B pertains to merely some possible embodiments and/or ways to implement flexible runtime assignments of IP addresses to pods in an arbitrary containerized system and/or in its environment. Many variations are possible, for example, one embodiment is specific to an embodiment that operates partially or fully within an Amazon Web Services (AWS) environment.

Embodiments that Operate Partially or Fully within an Amazon Web Services (AWS) Environment

FIG. 5A and FIG. 5B relate to a containerized system having a worker node that carries out configuration operations in an AWS cloud environment. In this embodiment, the process flow described in FIG. 5B is applied within the architecture of FIG. 5A. Specifically, and as shown, within worker node 502, there exists a supervisory pod that bounds a supervisory pod's network namespace 424. At operation 7, the supervisor, possibly through use of agent 506 assigns an IP address to the eth0 interface 426. Following this, the eth0 (ENI) calls for an address update event from a netlink facility (operation 8). As used herein and specifically in Linux or Linux-like environments, the term ‘netlink’ or ‘netlink facility’ refers to a socket-oriented mechanism used for communication between an operating system's kernel and user-space processes. In the context of the disclosure herein, a netlink facility is utilized to track IP address assignments and removals on a given network interface. That is, when an IP address is added to a given network interface or removed from a given network interface, the kernel generates an event on a corresponding netlink socket. As such a netlink facility serves as a mechanism to monitor change events on an interface. As an alternative to noticing changes on an interface via a netlink event, there are other methods such as periodically polling the interface, which other methods can be employed instead of, or in addition to, the netlink method. As can be understood, and as used herein, a netlink facility provides a mechanism to monitor network interfaces for IP address changes. Various netlink-specific implementations involve kernel-level tracking of events related to the addition or removal of IP addresses on a given interface. Notification of such events occur in real-time.

In various Kubernetes-specific embodiments, a “netlink event” or “netlink facility” refers to a communication of networking information between a kernel process and a user space process of a Kubernetes containerized system. The deployment and functionality of “netlink” is described in RFC3549.

A netlink-informed address update event is detectable by the container networking interface process 504. This is because the container networking interface process 504 within the container networking interface operator pod 412 continually monitors the eth0 interface for such events (see the dotted arrow labeled monitor interface using netlink 508). Subsequently (at operation 9) the container networking interface process 504 invokes the AWS API (e.g., from cloud APIs 430) to add the newly assigned IP to ENI. This then sets up the configuration such that the container networking interface process can record the newly-assigned IP address into network configuration store 418 (operation 10).

The foregoing discussion of FIG. 5A pertains to merely some possible architectures and signaling flows. Many variations are possible, for example, the worker node operation sequence as comprehended in the foregoing can be implemented in any environment, one example of which is shown and described as pertains to FIG. 5B.

FIG. 5B presents an example partitioning of setup operations as used to configure worker nodes in a cloud environment. As an option, one or more variations of partitioning 5B00 or any aspect thereof may be implemented in the context of the architecture and functionality of the embodiments described herein and/or in any environment.

In particular, FIG. 5B presents a flowchart showing possible responses to certain monitored events that occur in systems that eliminate network address translations and associated IP hops by assigning published IP addresses dynamically to pods of a containerized computing system.

As shown, the process begins within the supervisory pod 503. Specifically, the first step of the depicted flowchart is to assign a new IP address to the network interface (step 542). Next, configuration monitoring is carried out within the container networking interface pod 512. Upon occurrence of a netlink event (step 544), CNI pod 512 raises an action to cause a change in (or in addition of) an IP address for a particular pod's network interface (step 546). The steps thereafter involve performing the required configurations to make the pod IP reachable via the IP address that can be (or was) derived from parsing of the netlink event. Step 548 serves to record the new IP address in local store as (for example) a secondary IP address.

### Additional Practical Application Examples

The foregoing discussions pertain to merely some possible embodiments and/or ways to implement the herein-disclosed techniques. As a further discussion, consider implementing a container network interface plug-in with additional functionality (in addition to standard container networking interface spec functionality) as shown in Table 1.

TABLE 1
Container network interface plug-in functionalities

| Index | Description |
|---|---|
| 1 | A container network interface plug-in monitors the network namespace of the pod to get IP |
| | address assignment/un-assignment events. This monitoring can be implemented using netlink |
| | events OR by periodically checking IPs on the pod interface and figuring out modifications by |
| | comparing with previous state OR combinations of both these (e.g., via netlink communications |
| | and/or periodic polling). |
| 2 | A container network interface plug-in records the following in a local file based store: pod-id, |
| | pod-network-namespace, pod-interface-name, pod-primary-ip, secondary-ip-list, etc. Such a file |
| | is typically maintained by most of the container network interface plug-ins, but important |
| | additional data here is “secondary-ip-list” which records the additional IPs assigned to the pod. |
| 3 | A container network interface operator or other controller component defines the CRD (custom |
| | resource definition) to represent an IP address assignment. A CRD for IP assignment has a |
| | selector field to select a specific pod and the IP address. |

### Additional IP Address Reservations and Assignments

Given a CNI plug-in with additional functionalities such as described above, additional IP addresses can be assigned by any of the mechanisms shown in Table 2.

TABLE 2
Additional IP address assignments

| Index | Description |
|---|---|
| 1 | Additional IP addresses can be assigned to the pod's network interface within the pod itself. This |
| | can be done using IP aliasing or “ip addr add” from the pod itself (or any other method). |
| 2 | Additional IP addresses can be assigned by creating a CR (Custom Resource) that defines |
| | {pod-selector, IP-address} mapping. Here the pod-selector can be any filter that selects the pod |
| | uniquely. A baseline filter would be ‘pod-id’. |
| 3 | Additional IP addresses can be from the same subnet as a primary IP address (primary IP is the |
| | one assigned at the time of pod creation) of the pod OR it can be from a different subnet. When |
| | additional IP addresses are from a different subnet, a new network interface will be configured |
| | for the pod. |

### Examples of how Additional IP Assignment Will Work for a Pod

Example 1: Assignment using custom resource: A pod is created with the IP address 10.20.0.10/24. Consider that a pod gets scheduled on worker-node node1. A CNI plug-in running on this worker-node will configure the network for this pod. A CNI plug-in can not only configure the underlay network as described supra, but the same technique can be used for other types of network configurations (like overlays, bridges etc.). A CNI also records the attributes such as pod-id, pod-network-namespace, pod-interface-name, pod-primary-ip, and so on in a local file. Later a user might decide to assign one more IP address from the same subnet to the pod. User creates a CR with pod-selector based on pod-name and additional IP from same subnet.

Example 2: Dynamic IP address assignment to pods: In supervisory systems, there may be two sources of IP addresses. (1) Data Services IP (DSIP) and (2) cluster external IP addresses. These IP addresses are configured on active supervisory system nodes and can move to different supervisory systems nodes dynamically. When running a supervisory system's stack in the K8s environment, what is needed is a mechanism/technique that allows us to dynamically configure assigned IP addresses to executable container components. The foregoing provides mechanisms to assign additional IP addresses to a supervisory system in a running pod. These additional IP addresses should be assigned to the network interface inside the pod. Thenceforth, that pod should be reachable using any of the IP addresses assigned to it. When the pod migrates to a different node, additional IPs should also move along with the pod.

The foregoing shows how to implement a system that can assign and/or remove additional IP address to/from pod at runtime. Assigning IP addresses dynamically is useful for deploying supervisory systems (i.e., OS-like supervisors and/or applications) in the K8s environment.

### Instruction Code Examples

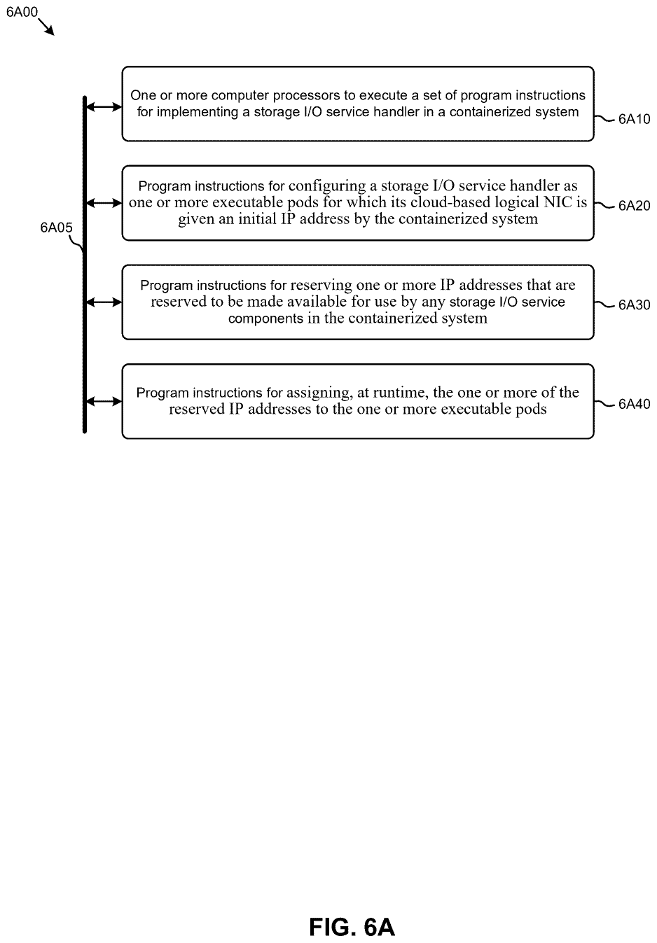

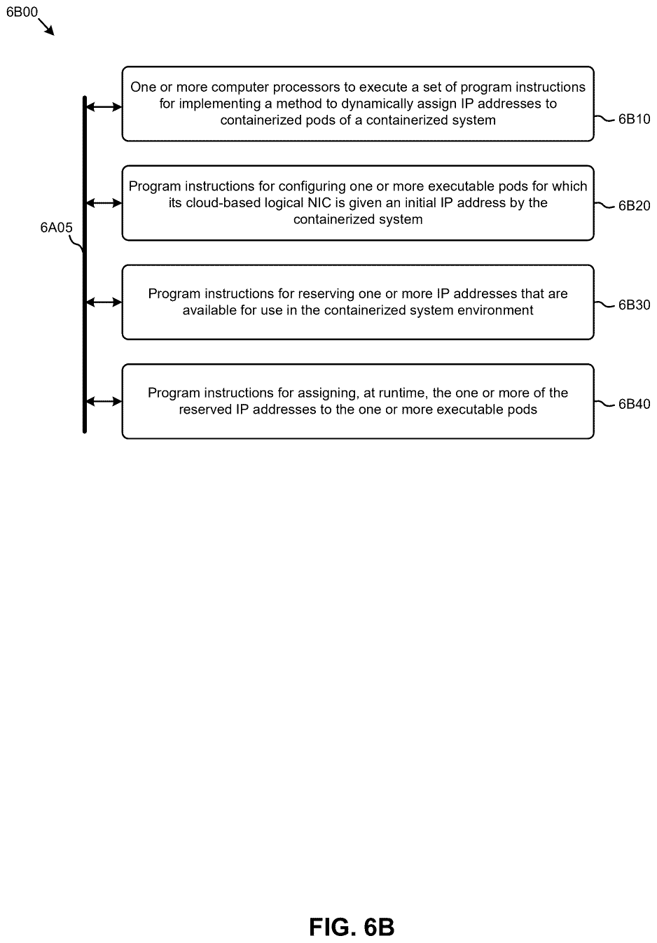

FIG. 6A depicts system 6A00 as an arrangement of computing modules that are interconnected so as to operate cooperatively to implement certain of the herein-disclosed embodiments. This and other embodiments present particular arrangements of elements that, individually or as combined, serve to form improved technological processes that address containerized systems that do not support runtime changes to the IP address of executable service modules. The partitioning of system 6A00 is merely illustrative and other partitions are possible.

Variations of the foregoing may include more or fewer of the shown modules. Certain variations may perform more, or fewer (or different) steps and/or certain variations may use data elements in more, or in fewer, or in different operations. Still further, some embodiments include variations in the operations performed, and some embodiments include variations of aspects of the data elements used in the operations. As an option, system 6A00 may be implemented in the context of the architecture and functionality of the embodiments described herein. Of course, however, system 6A00 or any operation therein may be carried out in any desired environment. The system 6A00 comprises at least one processor and at least one memory, the memory serving to store program instructions corresponding to the operations of the system. As shown, an operation can be implemented in whole or in part using program instructions accessible by a module. The modules are connected to a communication path 6A05, and any operation can communicate with any other operations over communication path 6A05. The modules of the system can, individually or in combination, perform method operations within system 6A00. Any operations performed within system 6A00 may be performed in any order unless as may be specified in the claims. The shown embodiment implements a portion of a computer system, presented as system 6A00, comprising one or more computer processors to execute a set of program code instructions (module 6A10) and modules for accessing memory to hold program code instructions to perform: configuring the storage I/O service handler as one or more executable pods for which its cloud-based logical NIC is given an initial IP address by the containerized system (module 6A20); identifying one or more reserved IP addresses that are available for use in the containerized system (module 6A30); and assigning, at runtime, the one or more of the reserved IP addresses to the one or more executable pods (module 6A40).

FIG. 6B depicts system 6B00 as an arrangement of computing modules that are interconnected so as to operate cooperatively to implement certain of the herein-disclosed embodiments. The partitioning of system 6B00 is merely illustrative and other partitions are possible. The shown embodiment implements a method for dynamically assigning IP addresses to containerized pods of a containerized system by: configuring one or more executable pods for which its cloud-based logical NIC is given an initial IP address by the containerized system (module 6B20); reserving one or more IP addresses that are available for use in the containerized system environment (module 6B30); and assigning, at runtime, at least one of the one or more reserved IP addresses to the one or more executable pods (module 6B40).

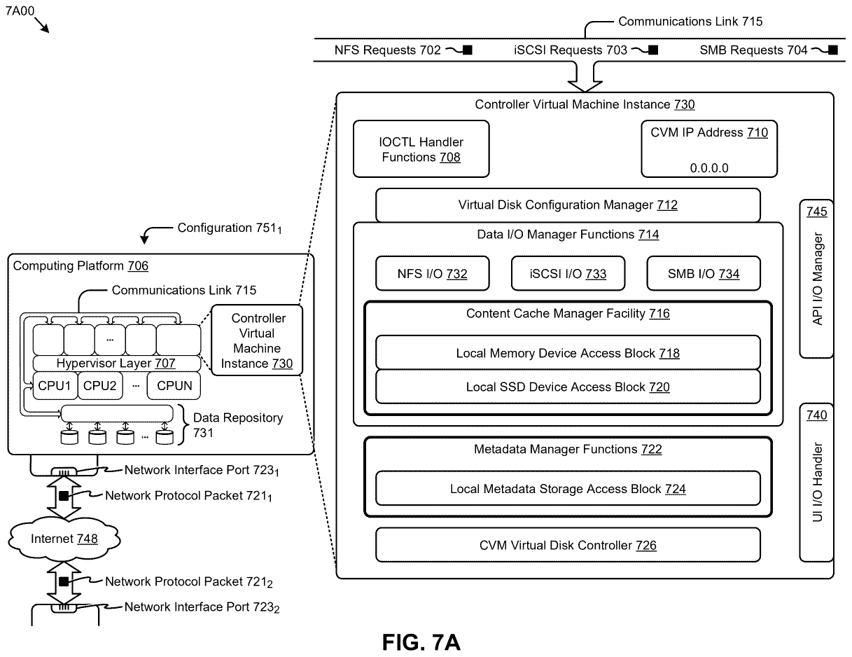

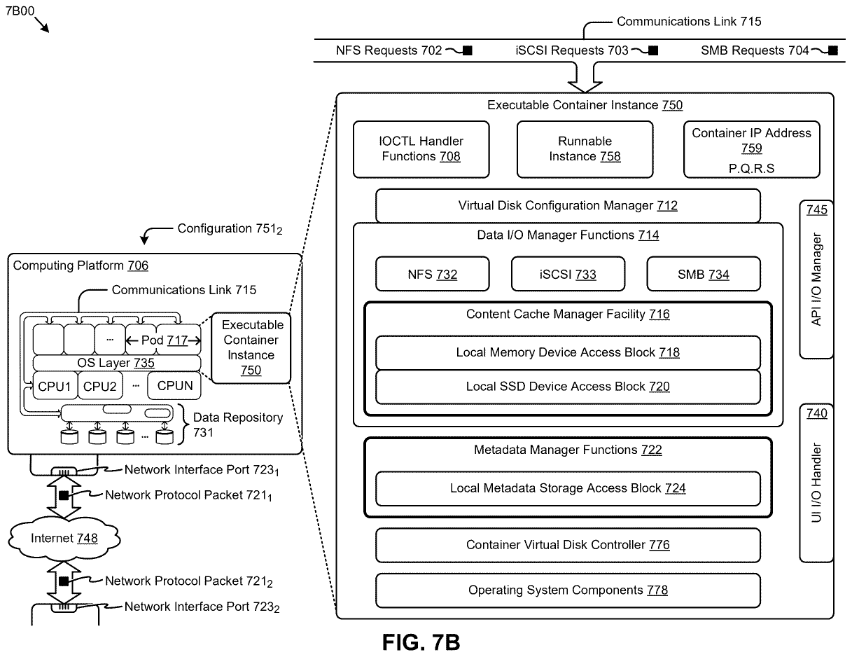

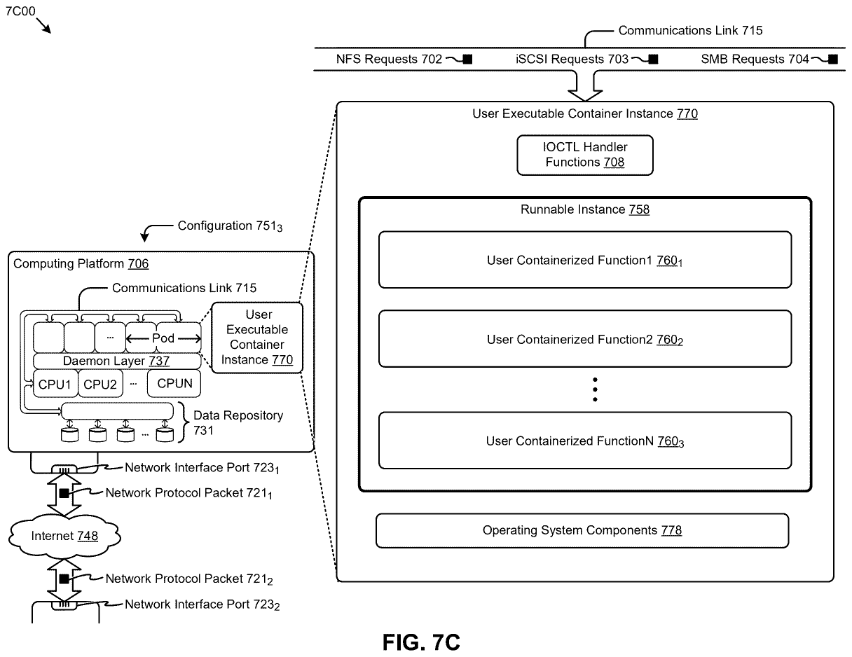

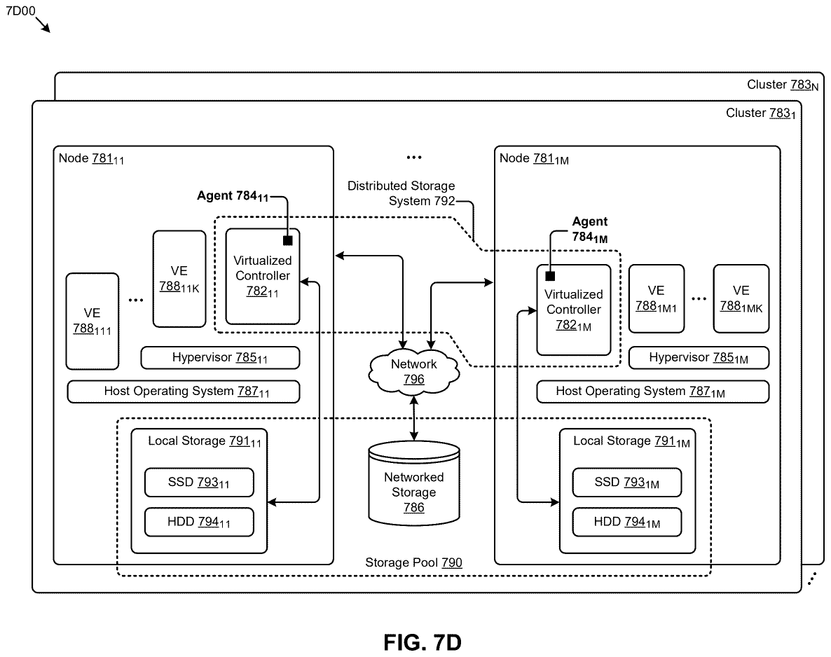

The foregoing can be implemented in various computing environments involving a containerized system. Moreover, the foregoing can be implemented in various computing environments involving architectures having both a virtualization system and a containerized system (e.g., a cloud-based containerized system), some of which architectures are shown and described infra as pertains to FIG. 7A through FIG. 7D.

### Sample System Architectures

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 707). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a controller virtual machine instance 730 in configuration 751₁ that is further described below as pertaining to implementation of such a controller virtual machine instance 730. Configuration 751₁ supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS 732, iSCSI 733, SMB 734, etc.).

In addition to block IO functions, configuration 751₁ supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751₁ can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751₁ can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to eliminating network address translations and associated IP hops by assigning published IP addresses dynamically to pods of a containerized computing system. In some embodiments, a module may include one or more state machines and/or combinational logic used to implement or facilitate the operational and/or performance characteristics pertaining to eliminating network address translations and associated IP hops by assigning published IP addresses dynamically to pods of a containerized computing system.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of eliminating network address translations and associated IP hops by assigning published IP addresses dynamically to pods of a containerized computing system). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to eliminating network address translations and associated IP hops by assigning published IP addresses dynamically to pods of a containerized computing system, and/or for improving the way data is manipulated when performing computerized operations pertaining to deploy storage modules (e.g., iSCSI targets) having their own dynamically-assigned and dynamically-managed IP addresses.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENTT,” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance 750 in configuration 7512 that is further described below as pertaining to executable container instance 750. Configuration 7512 includes an operating system layer (the shown OS layer 735) that performs addressing functions such as providing access to external requestors (e.g., user virtual machines or other processes) via an IP address 759 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 735) can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 717 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance 770 in configuration 751₃ that is further described below as pertaining to user executable container instance 770. Configuration 751₃ includes a daemon layer 737 that performs certain functions of an operating system.

User executable container instance 770 comprises any number of user containerized functions (e.g., user containerized function1 760₁, user containerized function2 760₂, . . . , user containerized functionN 760₃). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manage the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-cluster environment 7D00. The shown distributed virtualization system is configured to be used to implement the herein disclosed techniques. Specifically, the distributed virtualization system of FIG. 7D comprises multiple clusters (e.g., cluster 783₁, . . . , cluster 783_{N}) comprising multiple nodes that have multiple tiers of storage in a storage pool. Representative nodes (e.g., node 781₁₁, . . . , node 781_{1M}) and storage pool 790 associated with cluster 783₁ are shown. Each node can be associated with one server, multiple servers, or portions of a server. The nodes can be associated (e.g., logically and/or physically) with the clusters. As shown, the multiple tiers of storage include storage that is accessible through a network 796, such as a networked storage 786 (e.g., a storage area network or SAN, network attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, . . . , HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor instance 785₁₁, . . . , hypervisor instance 785_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor instance 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor instance 785_{1M} and/or the kernel of host operating system 787_{1M}.

In certain embodiments, one or more instances of an agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to deploy storage modules (e.g., iSCSI targets) having their own dynamically-assigned and dynamically-managed IP addresses can be brought to bear through implementation of any one or more of the foregoing techniques. Moreover, any aspect or aspects of storage-oriented communications are highly latency sensitive can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for implementing a storage I/O service handler in a containerized system, the acts comprising:
configuring the storage I/O service handler as one or more executable pods for which its cloud-based logical NIC is given an initial IP address by the containerized system;
identifying one or more reserved IP addresses that are available for use in the containerized system; and
assigning, at runtime, the one or more of the reserved IP addresses to the one or more executable pods.

2. The non-transitory computer readable medium of claim 1, wherein the storage I/O service handler implements all or portions of at least one of, NFS, Samba, iSCSI, NVMe, or CIFS.

3. The non-transitory computer readable medium of claim 1, further comprising instructions which, when stored in memory and executed by the processor cause the processor to perform further acts of configuring multiple iSCSI targets as one or more executable pods that are assigned an initial IP address by the containerized system.

4. The non-transitory computer readable medium of claim 1, further comprising instructions which, when stored in memory and executed by the processor cause the processor to perform further acts of implementing a container network interface (CNI) function to implement network connectivity.

5. The non-transitory computer readable medium of claim 1, further comprising instructions which, when stored in memory and executed by the processor cause the processor to perform further acts of advising a leader process of the one or more of the reserved IP addresses that are assigned to the one or more executable pods.

6. The non-transitory computer readable medium of claim 1, wherein at least some of the one or more reserved IP addresses are static IP addresses.

7. The non-transitory computer readable medium of claim 6, wherein the static IP addresses retain at least a subset of attributes across lifetimes of an execution unit.

8. A method for implementing a storage I/O service handler in a containerized system, the method comprising:
configuring the storage I/O service handler as one or more executable pods for which its cloud-based logical NIC is given an initial IP address by the containerized system;
identifying one or more reserved IP addresses that are available for use in the containerized system; and
assigning, at runtime, the one or more of the reserved IP addresses to the one or more executable pods.

9. The method of claim 8, wherein the storage I/O service handler implements all or portions of at least one of, NFS, Samba, iSCSI, NVMe, or CIFS.

10. The method of claim 8, further comprising configuring multiple iSCSI targets as one or more executable pods that are assigned an initial IP address by the containerized system.

11. The method of claim 8, further comprising implementing a container network interface (CNI) function to implement network connectivity.

12. The method of claim 8, further comprising advising a leader process of the one or more of the reserved IP addresses that are assigned to the one or more executable pods.

13. The method of claim 8, wherein at least some of the one or more reserved IP addresses are static IP addresses.

14. The method of claim 13, wherein the static IP addresses retain at least a subset of attributes across lifetimes of an execution unit.

15. A system for implementing a storage I/O service handler in a containerized system, the system comprising:
a storage medium having stored thereon a sequence of instructions; and
a processor that executes the sequence of instructions to cause the processor to perform acts comprising,
configuring the storage I/O service handler as one or more executable pods for which its cloud-based logical NIC is given an initial IP address by the containerized system;
identifying one or more reserved IP addresses that are available for use in the containerized system; and
assigning, at runtime, the one or more of the reserved IP addresses to the one or more executable pods.

16. The system of claim 15, wherein the storage I/O service handler implements all or portions of at least one of, NFS, Samba, iSCSI, NVMe, or CIFS.

17. The system of claim 15, further comprising instructions which, when stored in memory and executed by the processor cause the processor to perform further acts of configuring multiple iSCSI targets as one or more executable pods that are assigned an initial IP address by the containerized system.

18. The system of claim 15, further comprising instructions which, when stored in memory and executed by the processor cause the processor to perform further acts of implementing a container network interface (CNI) function to implement network connectivity.

19. The system of claim 15, further comprising instructions which, when stored in memory and executed by the processor cause the processor to perform further acts of advising a leader process of the one or more of the reserved IP addresses that are assigned to the one or more executable pods.

20. The system of claim 15, wherein at least some of the one or more reserved IP addresses are static IP addresses.
